(19) United States
(12) Patent Application Publication
(10) Pub. No.: US 2014/0061109 A1
(43) Pub. Date: Mar. 6, 2014

(54) OIL FILM CLEANER

(71) Applicant: Yao-Tang Yu, Changhua County (TW)

(72) Inventor: Yao-Tang Yu, Changhua County (TW)

(21) Appl. No.: 13/597,266

(22) Filed: Aug. 29, 2012

(51) Int. Cl. A01K 63/04

(52) U.S. Cl. 210/167.21

(57) ABSTRACT

An oil film cleaner includes a connected assembly connected to a buoy tube. The connected assembly has a first connected pipe and a second connected pipe. The first connected pipe is connected to the second connected pipe. The buoy tube is assembled to the second connected pipe and having a plurality of floating blocks and drainage openings defined thereon. Under this arrangement, when the bottom of each drainage opening is lower than a water level, dust and oil films which are floating on the surface of water are guided by the drainage openings and are ejected out by the buoy tube so as to maintain a cleanness of the surface of water.

### BACKGROUND OF THE INVENTION

1. Field of the Invention

The present invention relates to a water cleaning device, and more particularly to an oil film cleaner.

2. Description of Related Art

Generally, people decorate their house with a variety of decorations like photographs, vases, dolls or aquarium tanks. Among these decorations, the aquarium tanks may be the most popular one because there are so many kinds of aquatic animals and aquatic plants can be raised in the aquarium tanks. In addition, some people raise a plenty of fishes or other aquatic animals in the aquarium tank instead of raising cats or dogs in their house. However, since the air pollution become worse and worse recently, dusts in the air will frequently float on the surface of water of the aquarium tank and combine with the carbon dioxide which are ejected by the aquatic organisms in the aquarium tank to form oil films. The formation of the oil films will interfere with the photosynthesis of the aquatic organisms because the efficiency of exchange between the oxygen and the carbon dioxide and the amount of lights which are permeated into the aquarium tank are both decreased. Therefore, for owners of aquarium tanks, to maintain the cleanness of water becomes a big issue.

A conventional oil film remover comprises a tube body, a switch and a plurality of floating pipes, the tube body being fastened inside the aquarium tank by a fastening component, the tube body having a dipping base formed at a bottom thereof, the dipping base having a plurality of grooves opened around an outer periphery thereof, the dipping base having a threaded structure defined at an inner wall thereof, the switch comprising a rod body, the rod body having a blocking sheet defined at one end thereof, the rod body having a threaded portion defined at another end thereof, the blocking sheet having a rotating bar extended from one end thereof, the rotating bar being opposite to the rod body, the threaded portion of the switch is engaged with the threaded structure of the tube body to adjust a flowing rate of water from the aquarium tank into the conventional oil film remover. Under this arrangement, when a bottom of each groove is lower than a water level, oil films which are floating on the surface of water are guided and ejected out by the floating pipes so as to maintain a cleanness of the surface of water.

However, the conventional oil film remover has a disadvantage as following.

Since the number of the elements of the conventional oil film remover is so many, manufacturing the conventional oil film remover is time consuming; moreover, since the structure of the elements of the conventional oil film remover is complicated, repairing and maintaining the conventional oil film remover is not an easy task.

The present invention has arisen to mitigate and/or obviate the disadvantage of the conventional.

### SUMMARY OF THE INVENTION

The main objective of the present invention is to provide a water cleaning device.

To achieve the objective, An oil film cleaner comprises a connected assembly and a buoy tube, the connected assembly connected to the buoy tube, the connected assembly comprising a first connected pipe and a second connected pipe, one end of the first connected pipe connected to one end of the second connected pipe, one end of the buoy tube assembled to another end of the second connected pipe so that the buoy tube is communicated with the second connected pipe, the buoy tube having a plurality of floating blocks uniformly protruded around another end thereof, at least one drainage opening formed between each two floating blocks, a bottom of each drainage opening being lower than a bottom part of each floating block, each floating block having a chamber defined therein so that the buoy tube floats on the surface of water. Wherein, the first connected pipe further has a motor assembled on another end thereof; the motor has an inhaling opening opened thereon so as to maintain the cleanness of the surface of water; the first connected pipe has a plurality of buffering holes defined around an outer periphery of one end thereof; the second connected pipe has a sleeving portion defined at one end thereof; a diameter of the sleeving portion is longer than a diameter of the first connected pipe; the sleeving portion of the second connected pipe sleeves on one end of the first connected pipe; the number of the buffering holes which are directly exposed to water are adjusted so as to increase or decrease the attracting force which acts on the buoy tube; the second connected pipe has a inserting portion defined at one end thereof; a diameter of the inserting portion is shorter than the diameter of the first connected pipe; the inserting portion of the second connected pipe is inserted into one end of the first connected pipe; the number of the buffering holes which are directly exposed to water are adjusted so as to increase or decrease the attracting force which acts on the buoy tube; the first connected pipe is connected to the second connected pipe via a third connected pipe; one end of the third connected pipe is connected to one end of the first connected pipe, and another end of the third connected pipe is connected to one end of the second connected pipe. Under this arrangement, the buoy tube floats on the surface of water via the chambers of the floating blocks; when the bottom of each drainage opening of the buoy tube is lower than a water level, dust and oil films which are floating on the surface of water are guided by the drainage openings, and then said dust and oil films are ejected out by the buoy tube through the connected assembly so as to maintain a cleanness of the surface of water.

An oil film cleaner comprises a connected assembly and a buoy tube, the connected assembly connected to the buoy tube, the connected assembly comprising a first connected pipe and a second connected pipe, one end of the first connected pipe connected to one end of the second connected pipe, one end of the buoy tube assembled to another end of the second connected pipe so that the buoy tube is communicated with the second connected pipe, the buoy tube having a plurality of floating blocks uniformly protruded around another end thereof, the density of the buoy tube being smaller than the density of water, at least one drainage opening formed between each two floating blocks, a bottom of each drainage opening being lower than a bottom part of each floating block. Wherein, the first connected pipe further has a motor assembled on another end thereof; the motor has an inhaling opening opened thereon so as to maintain the cleanness of the surface of water; the first connected pipe has a plurality of buffering holes defined around an outer periphery of one end thereof; the second connected pipe has a sleeving portion defined at one end thereof; a diameter of the sleeving portion is longer than a diameter of the first connected pipe; the sleeving portion of the second connected pipe sleeves on one end of the first connected pipe; the number of the buffering holes which are directly exposed to water are adjusted so as to increase or decrease the attracting force which acts on the buoy tube; the second connected pipe has a inserting portion defined at one end thereof; a diameter of the inserting portion is shorter than the diameter of the first connected pipe; the inserting portion of the second connected pipe is inserted into one end of the first connected pipe; the number of the buffering holes which are directly exposed to water are adjusted so as to increase or decrease the attracting force which acts on the buoy tube; the first connected pipe is connected to the second connected pipe via a third connected pipe; one end of the third connected pipe is connected to one end of the first connected pipe, and another end of the third connected pipe is connected to one end of the second connected pipe; the density of the buoy tube is smaller than 1 g/cm³. Under this arrangement, the buoy tube floats on the surface of water because of a density difference between water and the buoy tube; when a bottom of the drainage openings of the buoy tube is lower than a water level, dust and oil films which are floating on the surface of water are guided by the drainage openings, and then said dust and oil films are ejected out by the buoy tube through the connected assembly so as to maintain a cleanness of the surface of water.

Further benefits and advantages of the present invention will become apparent after a careful reading of the detailed description with appropriate reference to the accompanying drawings.

### BRIEF DESCRIPTION OF THE DRAWINGS

FIG. 1 is a schematic view of a first embodiment of an oil film cleaner of the present invention which is assembled on an aquarium;

FIG. 2 is an exploded view of the first embodiment of the oil film cleaner;

FIG. 3 is a partially enlarged view of a buoy tube of the first embodiment of the oil film cleaner;

FIG. 4 is a cross-sectional view along line 4-4 shown in FIG. 2 for showing a first connected pipe is sleeved by a sleeving portion of a second connected pipe;

FIG. 5 is a cross-sectional view of the oil film cleaner for showing an inserting portion of the second connected pipe is inserted into the first connected pipe;

FIG. 6 is a cross-sectional view of the first embodiment of the oil film cleaner for showing the first connected pipe and the second connected pipe is linked by a third connected pipe; and

FIG. 7 is a cross-sectional view of a second embodiment of the oil film cleaner of the present invention.

### DETAILED DESCRIPTION OF THE INVENTION

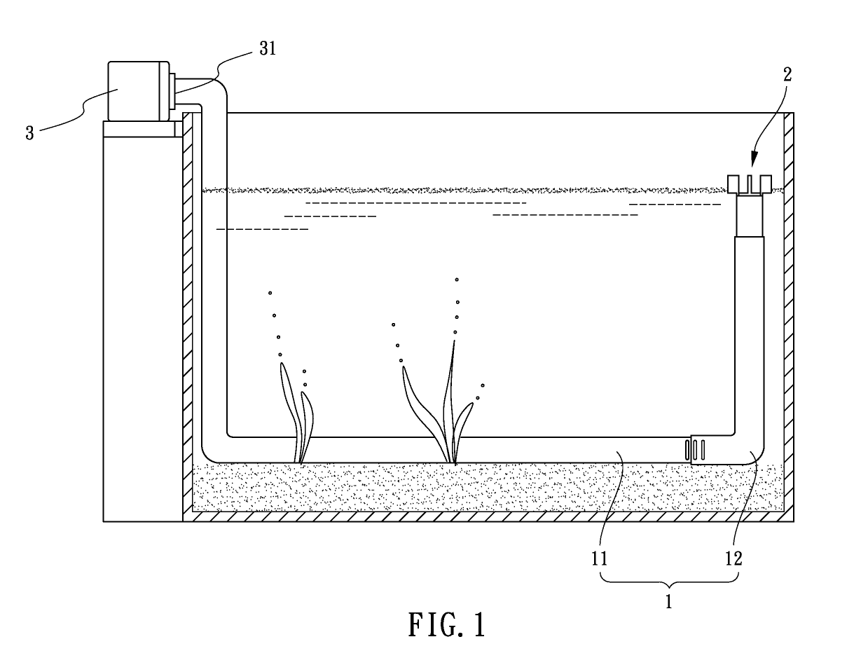

Referring to FIGS. 1-4, a first embodiment of an oil film cleaner in accordance with the present invention comprises a connected assembly 1 and a buoy tube 2.

The connected assembly 1 is connected to the buoy tube 2. The connected assembly 1 comprises a first connected pipe 11 and a second connected pipe 12. One end of the first connected pipe 11 is connected to one end of the second connected pipe 12.

One end of the buoy tube 2 is assembled to another end of the second connected pipe 12 so that the buoy tube 2 is communicated with the second connected pipe 12. The buoy tube 2 has a plurality of floating blocks 21 uniformly protruded around another end thereof. At least one drainage opening 22 are formed between each two floating blocks 21. A bottom of each drainage opening 22 is lower than a bottom part of each floating block 21. Each floating block 21 has a chamber 211 defined therein.

Under this arrangement, the buoy tube 2 floats on the surface of water via the chambers 211 of the floating blocks; when the bottom of each drainage opening 22 of the buoy tube 2 being lower than a water level, dust and oil films which are floating on the surface of water are guided by the drainage openings 22, and then said dust and oil films are ejected out by the buoy tube 2 through the connected assembly 1 so as to maintain a cleanness of the surface of water.

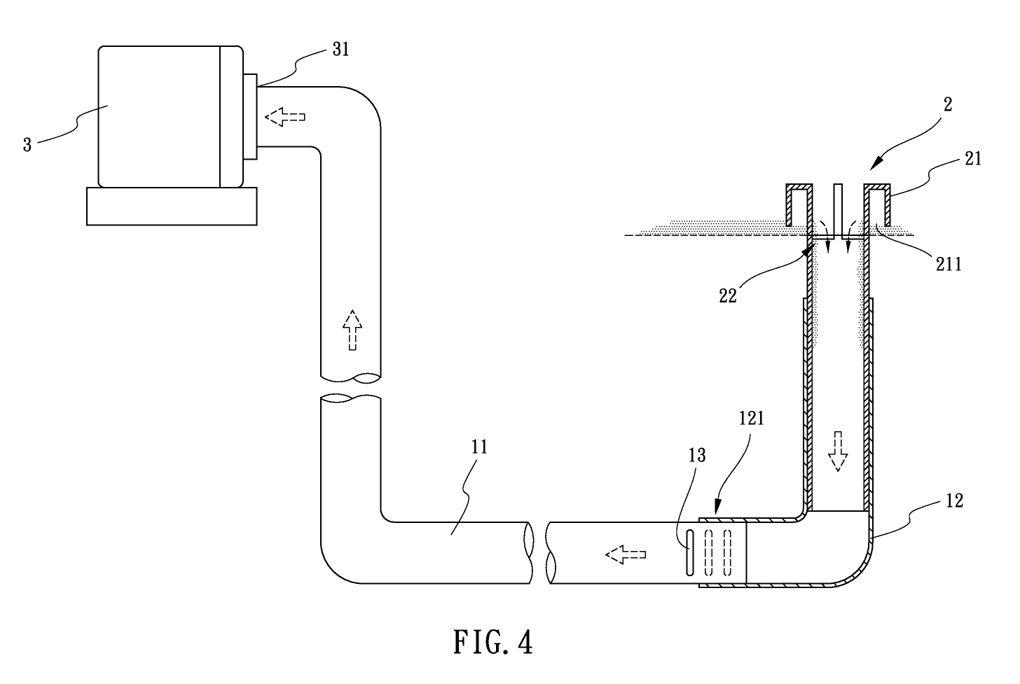

Referring to FIG. 4, the first connected pipe 11 further has a motor 3 assembled on another end thereof. The motor 3 has an inhaling opening 31 opened thereon. As a result, when a user turns on the power of the motor 3, the bottom of the buoy tube 2 becomes lower than the water level because of an attracting force provided by the motor 3; thereby said dust and oil films are guided by the drainage opening 22 and are moved from the buoy tube 2 to the inhaling opening 31 of the motor 3 via the connected assembly 1 to be ejected out so as to maintain the cleanness of the surface of water.

Referring to FIG. 1-4, the first connected pipe 11 has a plurality of buffering holes 13 defined around an outer periphery of one end thereof. Therefore, the value of the attracting force acting on the buoy tube 2 is decreased because parts of the attracting force are acting on the buffering holes 13 which are directly exposed to water, and a degree of sinking of the buoy tube 2 becomes controllable (The alignment of the buffering holes 13 and the number of the buffering holes 13 are not limited in the present invention.).

Three types of the connected assembly 1 with different combination forms are further described as following.

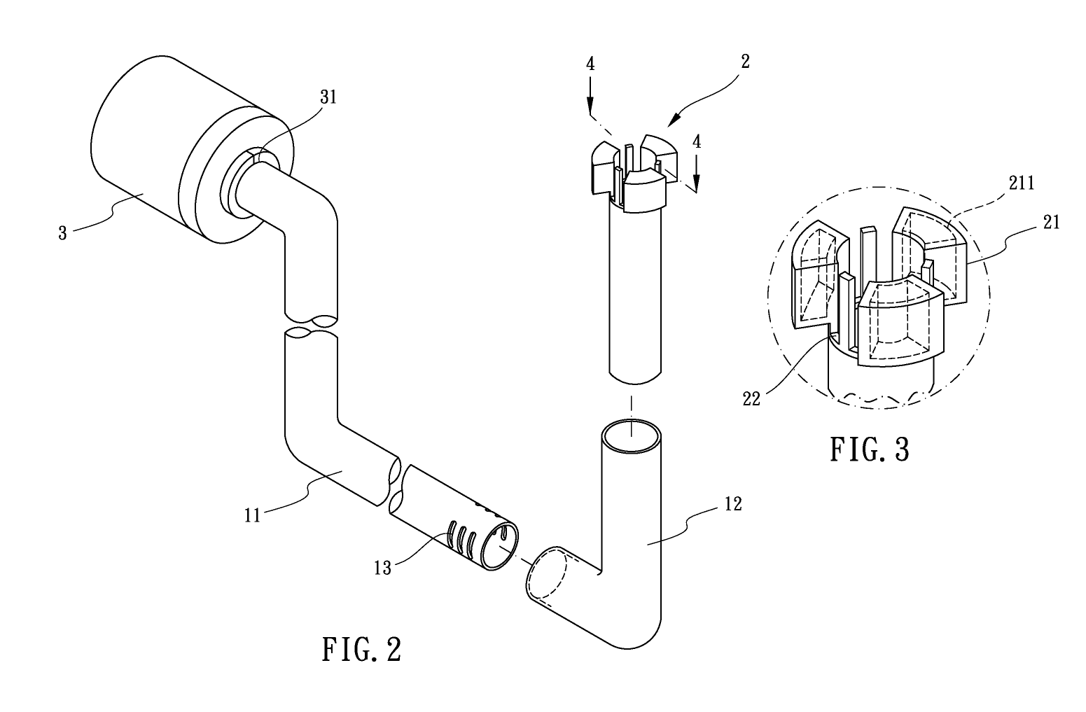

1. For the first type of the connected assembly 1, as shown in FIG. 2 and FIG. 4, the second connected pipe 12 has a sleeving portion 121 defined at one end thereof. A diameter of the sleeving portion 121 is longer than a diameter of the first connected pipe 11. The sleeving portion 121 of the second connected pipe 12 is sleeved on one end of the first connected pipe 11. Under this arrangement, the number and the location of the buffering holes 13 which are directly exposed to water are adjustable by the positions between the sleeving portion 121 of the second connected pipe 12 and the buffering holes 13 of the first connected pipe 11. Thereby, when more buffering holes 13 are exposed to water, the attracting force which acts on the buoy tube 2 becomes weaker and the degree of sinking of the buoy tube 2 is decreased.

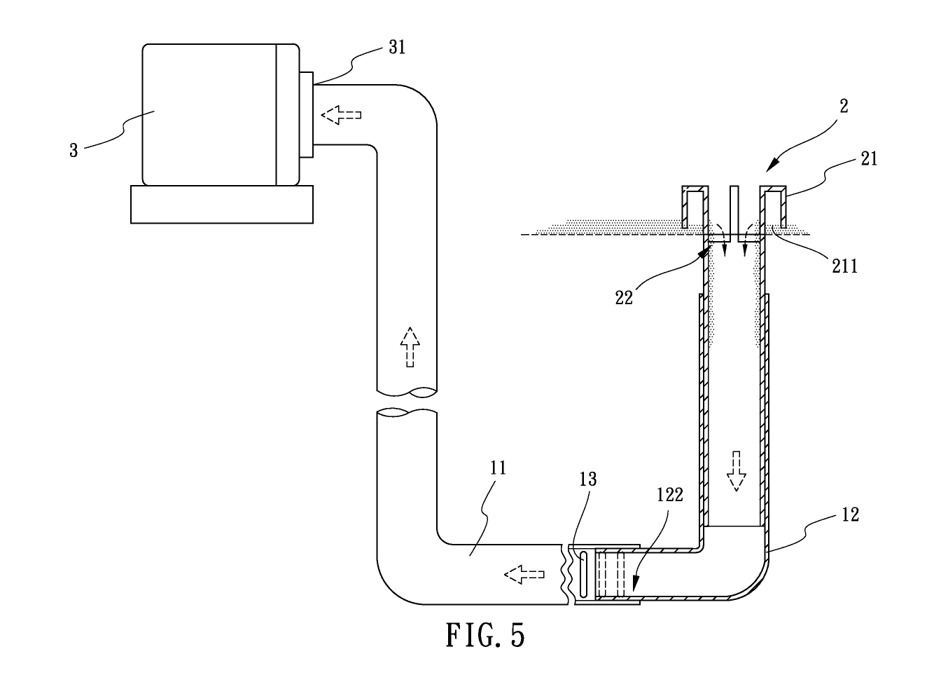

2. For the second type of the connected assembly 1, as shown in FIG. 5, the second connected pipe 12 has an inserting portion 122 defined at one end thereof. A diameter of the inserting portion 122 is shorter than the diameter of the first connected pipe 11. The inserting portion 122 is inserted into one end of the first connected pipe 11. Under this arrangement, the number and the location of the buffering holes 13 which are directly exposed to water are adjustable by the position between the inserting portion 122 of the second connected pipe 12 and the buffering holes 13 of the first connected pipe 11. Thereby, when more buffering holes 13 are exposed to water, the attracting force which acts on the buoy tube 2 becomes weaker and the degree of sinking of the buoy tube 2 is decreased.

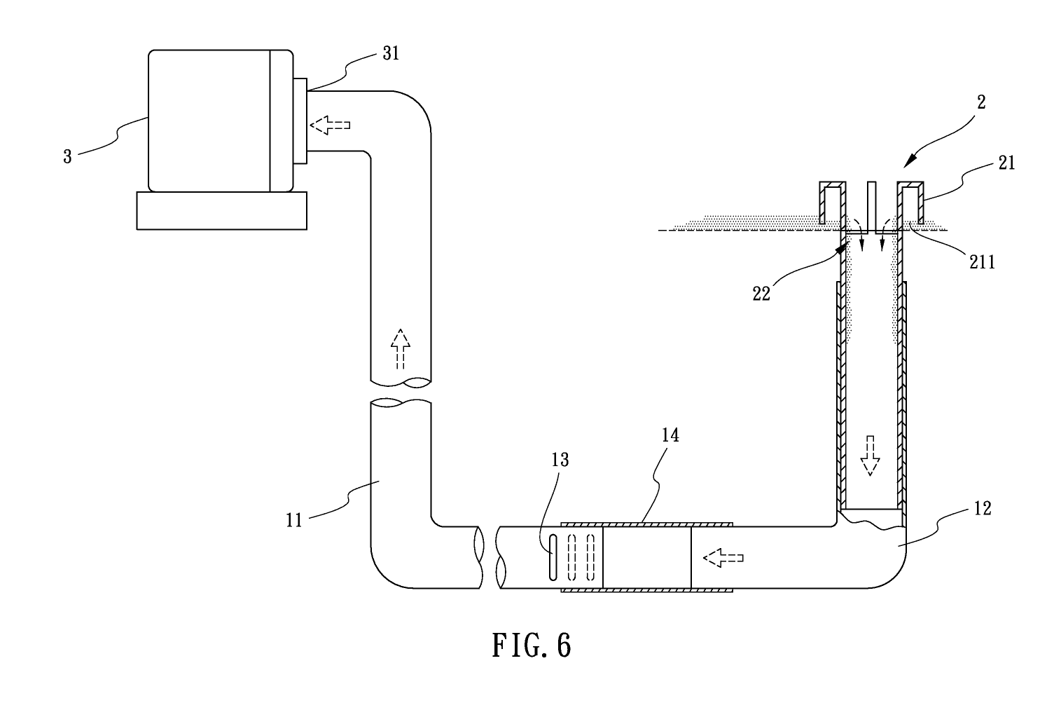

3. For the third type of the connected assembly 1, as shown in FIG. 6, the first connected pipe 11 is connected to the second connected pipe 12 via a third connected pipe 14. One end of the third connected pipe 14 is connected to one end of the first connected pipe 11, and another end of the third connected pipe 14 is connected to one end of the second connected pipe 12 (The connecting methods among the first connected pipe 11, the second connected pipe 12, and the third connected pipe 14 are not limited in the present invention.).

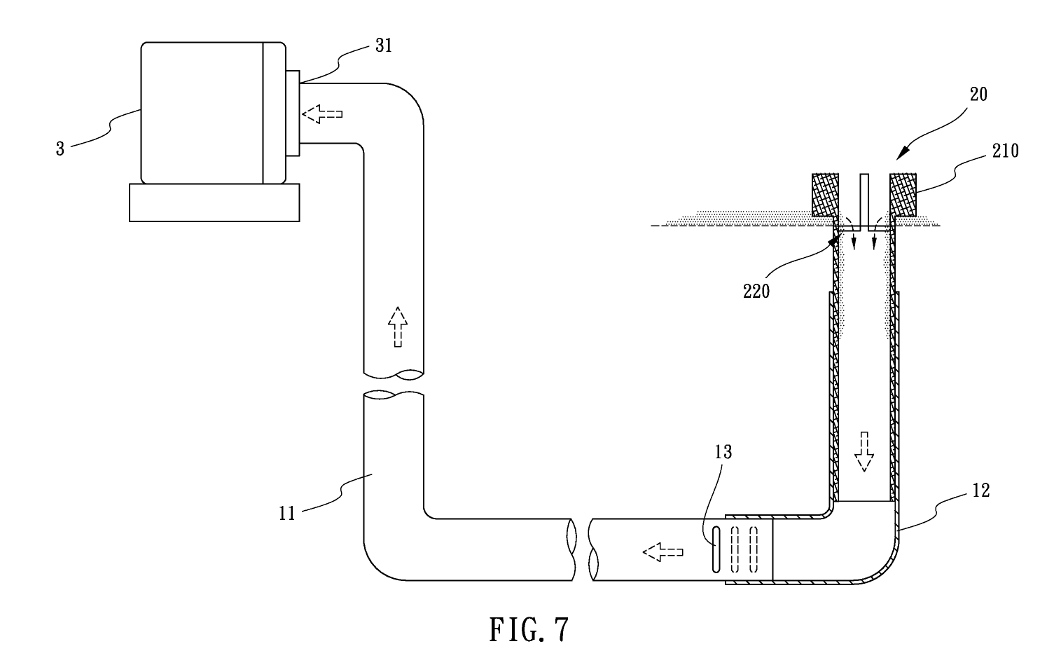

FIG. 7 shows a second embodiment of the oil film cleaner in accordance with the present invention (Only the differences between the second embodiment and the first embodiment are further described.). The density of the buoy tube 20 is smaller than the density of water; in particular, the density of the buoy tube 20 is smaller than 1 g/cm³. The floating blocks 210 do not have any chambers 211 defined therein. Another end of the buoy tube 20 is floating on the water level because of the density difference between the buoy tube 20 and water. Under this arrangement, when the user turns on the power of the motor 3, the bottom of the buoy tube 20 becomes lower than the water level because of the attracting force provided by the motor 3; thereby said dust and oil films are guided by the drainage opening 220 and moved from the buoy tube 20 to the inhaling opening 31 of the motor 3 via the connected assembly 1 to be ejected out so as to maintain the cleanness of the surface of water.

Moreover, either the buoy tube 20 or the floating blocks 210 can be made of plastic or materials whose density is smaller than water. (Generally, the density among different kinds of plastics is about 0.9-2.3 g/cm³; in addition, the density among different kinds of foam plastics is much lower, about 0.01-0.5 g/cm³.) because of the density difference between the buoy tube 20 and water and a mathematical formula where a value of the buoyancy of an article is equal to a value of the volume under a liquid of the article multiplies a value of the density of the liquid, another end of the buoy tube 20 is floating on the water level. Therefore, when the user turns on the power of the motor 3, the bottom of the buoy tube 20 becomes lower than the water level because of the attracting force provided by the motor 3; thereby said dust and oil films are guided by the drainage opening 220 and moved from the buoy tube 20 to the inhaling opening 31 of the motor 3 via the connected assembly 1 to be ejected out so as to maintain the cleanness of the surface of water (The materials used in the buoy tube 20 and the floating blocks 210 are not limited in the present invention.).

Although the invention has been explained in relation to its preferred embodiment, it is to be understood that many other possible modifications and variations can be made without departing from the spirit and scope of the invention as hereinafter claimed.

What is claimed is:

1. An oil film cleaner comprising:
a connected assembly and a buoy tube;
the connected assembly connected to the buoy tube, the connected assembly comprising a first connected pipe and a second connected pipe, one end of the first connected pipe connected to one end of the second connected pipe; and
one end of the buoy tube assembled to another end of the second connected pipe so that the buoy tube is communicated with the second connected pipe, the buoy tube having a plurality of floating blocks uniformly protruded around another end thereof, at least one drainage opening formed between each two floating blocks, a bottom of each drainage opening being lower than a bottom part of each floating block, each floating block having a chamber defined therein so that the buoy tube floats on the surface of water;
wherein, the buoy tube floats on the surface of water via the chambers of the floating blocks; when the bottom of each drainage opening of the buoy tube is lower than a water level, dust and oil films which are floating on the surface of water are guided by the drainage openings, and then said dust and oil films are ejected out by the buoy tube through the connected assembly so as to maintain a cleanness of the surface of water.

2. The oil film cleaner as claimed in claim 1, wherein the first connected pipe further has a motor assembled on another end thereof; the motor has an inhaling opening opened thereon so as to maintain the cleanness of the surface of water.

3. The oil film cleaner as claimed in claim 2, wherein the first connected pipe has a plurality of buffering holes defined around an outer periphery of one end thereof.

4. The oil film cleaner as claimed in claim 3, wherein the second connected pipe has a sleeving portion defined at one end thereof; a diameter of the sleeving portion is longer than a diameter of the first connected pipe; the sleeving portion of the second connected pipe sleeves on one end of the first connected pipe; the number of the buffering holes which are directly exposed to water are adjusted so as to increase or decrease the attracting force which acts on the buoy tube.

5. The oil film cleaner as claimed in claim 3, wherein the second connected pipe has a inserting portion defined at one end thereof; a diameter of the inserting portion is shorter than the diameter of the first connected pipe; the inserting portion of the second connected pipe is inserted into one end of the first connected pipe; the number of the buffering holes which are directly exposed to water are adjusted so as to increase or decrease the attracting force which acts on the buoy tube.

6. The oil film cleaner as claimed in claim 1, wherein the first connected pipe is connected to the second connected pipe via a third connected pipe; one end of the third connected pipe is connected to one end of the first connected pipe, and another end of the third connected pipe is connected to one end of the second connected pipe.

7. An oil film cleaner comprising:
a connected assembly and a buoy tube;
the connected assembly connected to the buoy tube, the connected assembly comprising a first connected pipe and a second connected pipe, one end of the first connected pipe connected to one end of the second connected pipe; and
one end of the buoy tube assembled to another end of the second connected pipe so that the buoy tube is communicated with the second connected pipe, the buoy tube having a plurality of floating blocks uniformly protruded around another end thereof, the density of the buoy tube being smaller than the density of water, at least one drainage opening formed between each two floating blocks, a bottom of each drainage opening being lower than a bottom part of each floating block;
wherein, the buoy tube floats on the surface of water because of a density difference between water and the buoy tube; when a bottom of the drainage openings of the buoy tube is lower than a water level, dust and oil films which are floating on the surface of water are guided by the drainage openings, and then said dust and oil films are ejected out by the buoy tube through the connected assembly so as to maintain a cleanness of the surface of water.

8. The oil film cleaner as claimed in claim 7, wherein the first connected pipe further has a motor assembled on another end thereof; the motor has an inhaling opening opened thereon so as to maintain the cleanness of the surface of water.

9. The oil film cleaner as claimed in claim 8, wherein the first connected pipe has a plurality of buffering holes defined around an outer periphery of one end thereof.

10. The oil film cleaner as claimed in claim 9, wherein the second connected pipe has a sleeving portion defined at one end thereof; a diameter of the sleeving portion is longer than a diameter of the first connected pipe; the sleeving portion of the second connected pipe sleeves on one end of the first connected pipe; the number of the buffering holes which are directly exposed to water are adjusted so as to increase or decrease the attracting force which acts on the buoy tube.

11. The oil film cleaner as claimed in claim 9, wherein the second connected pipe has a inserting portion defined at one end thereof; a diameter of the inserting portion is shorter than the diameter of the first connected pipe; the inserting portion of the second connected pipe is inserted into one end of the first connected pipe; the number of the buffering holes which are directly exposed to water are adjusted so as to increase or decrease the attracting force which acts on the buoy tube.

12. The oil film cleaner as claimed in claim 7, wherein the first connected pipe is connected to the second connected pipe via a third connected pipe; one end of the third connected pipe is connected to one end of the first connected pipe, and another end of the third connected pipe is connected to one end of the second connected pipe.

13. The oil film cleaner as claimed in claim 7, wherein the density of the buoy tube is smaller than 1 g/cm³.
